(19) United States
(12) Patent Application Publication
(10) Pub. No.: US 2025/0296670 A1
(43) Pub. Date: Sep. 25, 2025

(54) DIRECT-DRIVE MOTOR WITH FULLY-ENCAPSULATED STATOR FOR UNDERWATER VEHICLES

(71) Applicant: Raytheon Company, Tewksbury, MA (US)

(72) Inventors: Jason P. Rosa, ATTLEBORO, MA (US); Samuel Williams, Newport, RI (US); Joseph M. Misulia, ATTLEBORO, MA (US); Peter E. Dennison, WESTMINSTER, MA (US); Curtis B. Carlsten, SEEKONK, MA (US); Peter M. Willey, RUMFORD, RI (US); Christopher N. Kuncho, ATTLEBORO, MA (US)

(21) Appl. No.: 18/615,440

(22) Filed: Mar. 25, 2024

(51) Int. Cl. B63G 8/08; B63G 8/00; H02K 5/132; H02K 5/167; H02K 11/27

(52) U.S. Cl. CPC B63G 8/08; B63G 8/001; H02K 5/132; H02K 5/167; H02K 11/27; B63G 2008/004

(57) ABSTRACT

An electric direct-drive motor for an underwater vehicle comprises a fully-encapsulated stator and a rotor. The fully-encapsulated stator may comprise a stator encapsulated in a thermally-conductive and electrically-isolative encapsulant. The encapsulant may be configured to align the rotor within the fully-encapsulated stator. The fully-encapsulated stator may have an internal surface to operate as a bearing surface for the rotor. A radial gap between the rotor and the internal surface may provide a fluid bearing between the rotor and stator. The internal surface of the fully-encapsulated stator operates as a bearing surface for the rotor and the radial gap provides a fluid bearing when operating in a flooded assembly. This allows the electric direct-drive motor to be directly exposed to seawater and the high external water pressure eliminating any need for a pressure compensated housing and dynamic seals and bearings.

### TECHNICAL FIELD

Embodiments pertain to electric motors. Some embodiments relate to direct-drive motors. Some embodiments relate to motors for underwater and undersea vehicles. Some embodiments relate to unmanned and autonomous underwater vehicles (UAVs).

### BACKGROUND

There is a growing demand for unmanned underwater vehicles in both commercial and military applications because they are cheaper, safer, and can perform multitude operations without the need and risk of onboard personnel. One issue with unmanned underwater vehicles is their ability to withstand and operate under high external pressure (e.g., full ocean depth). The ability to withstand and operate under high external pressure is particularly an issue for electric motors which require pressure compensated or oil filled housings, dynamic shaft seals, and bearings.

Thus, there are general needs for improved underwater vehicles. There are also general needs for underwater vehicles that do not require pressure compensated housings. There are also general needs for underwater vehicles that do not require dynamic shaft seals and bearings for electric motors.

### BRIEF DESCRIPTION OF THE DRAWINGS

FIG. 1A illustrates an underwater vehicle, in accordance with some embodiments.

FIG. 1B illustrates a conventional electric motor configuration.

FIG. 2A illustrates a functional diagram illustrating motors in an underwater vehicle, in accordance with some embodiments.

FIG. 2B is a sectional view of the motors in the underwater vehicle of FIG. 2A, in accordance with some embodiments.

FIG. 3 illustrates a fully-encapsulated stator of an electric motor, in accordance with some embodiments.

FIG. 4 illustrates an electric direct-drive motor, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some embodiments are directed to an electric direct-drive motor for an underwater vehicle comprising a fully-encapsulated stator and a rotor. The fully-encapsulated stator may comprise a stator encapsulated in a thermally-conductive and electrically-isolative encapsulant. The encapsulant may be configured to align the rotor within the fully-encapsulated stator. The fully-encapsulated stator may have an internal surface to operate as a bearing surface for the rotor. A radial gap between the rotor and the internal surface may provide a fluid bearing between the rotor and stator. The internal surface of the fully-encapsulated stator operates as a bearing surface for the rotor and the radial gap provides a fluid bearing when operating in a flooded assembly. This allows the electric direct-drive motor to be directly exposed to seawater and the high external water pressure eliminating any need for a pressure compensated housing and dynamic seals and bearings. These embodiments as well as others are discussed in more detail below.

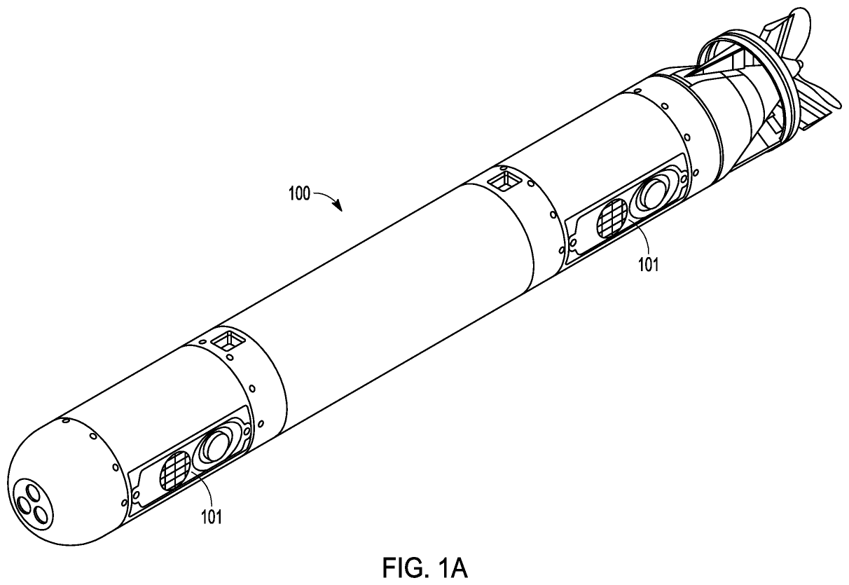

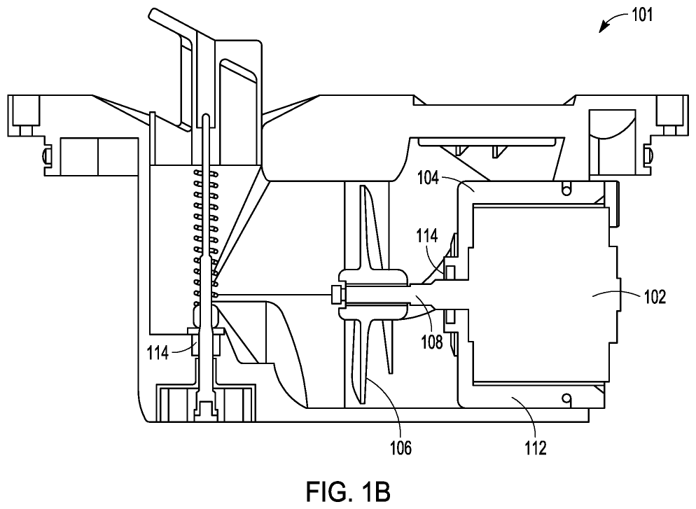

FIG. 1A illustrates an underwater vehicle, in accordance with some embodiments. Underwater vehicle 100 includes one or more electric motors 101. When conventional electric motors are used, underwater vehicle 100 may require static and dynamic seals, alignment bearings, and a pressure compensated housing to enable use of the conventional electric motors underwater at ocean depth.

FIG. 1B illustrates a conventional electric motor configuration. As illustrated in FIG. 1B, conventional electric motor 102 in an underwater vehicle may drive a propeller 106 via motor shaft 108. In this conventional configuration, conventional electric motor 102 may, for example, require a static seal 112 and dynamic seals 114 and a pressure compensated housing 104 to prevent water from entering the conventional electric motor 102. This is particularly a concern for seawater which is more conductive and corrosive.

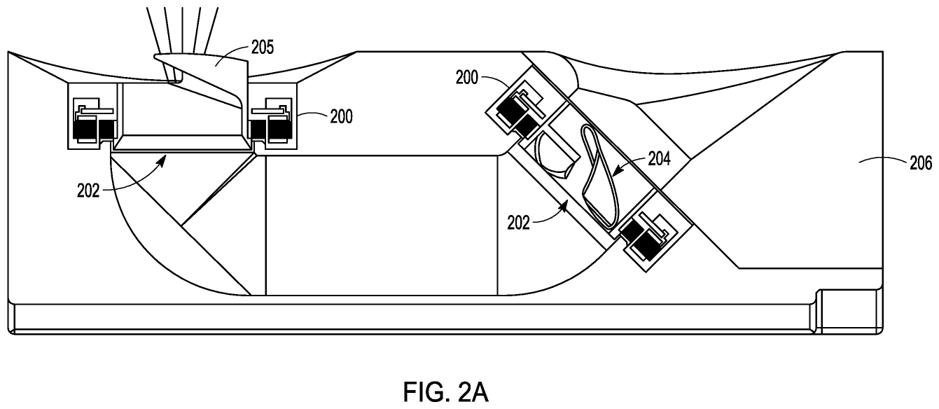

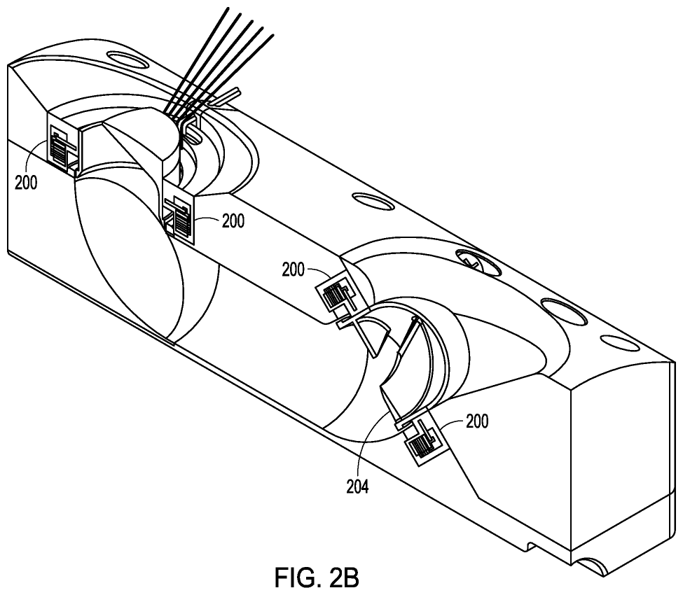

FIG. 2A illustrates a functional diagram illustrating motors in an underwater vehicle, in accordance with some embodiments. FIG. 2B is a sectional view of the motors in the underwater vehicle of FIG. 2A, in accordance with some embodiments.

The motors illustrated in FIG. 2A and FIG. 2B may be electric direct-drive motors 202, which may be directly coupled to a propeller 204 or a nozzle within a housing. Electric direct-drive motors 202 may be suitable for use as thruster motors in an underwater vehicle, such as underwater vehicle 100 (FIG. 1A). As illustrated in FIG. 2A and FIG. 2B, a first of the electric direct-drive motors 202 (configured as a thruster motor) with the propeller 204 (or impeller) controls thrust and moves fluid through the flow path. A second of the electric direct-drive motors 202 configured with a nozzle 205 directs the flow produced by the thruster motor. This configuration provides thrust and direction control for an underwater vehicle, such as an autonomous underwater vehicle (AUV). In some embodiments, thrust and direction may be provided with the same motor being used but with different controls, although the scope of the embodiments is not limited in this respect.

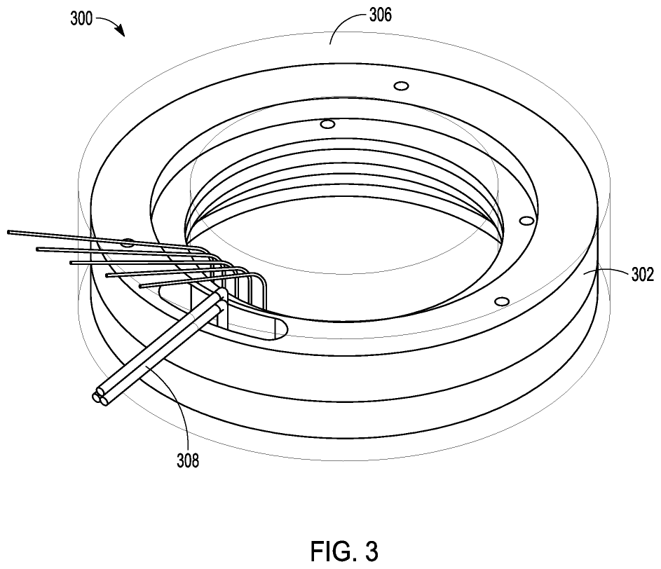

FIG. 3 illustrates a fully-encapsulated stator of an electric motor, in accordance with some embodiments. Fully-encapsulated stator 300 may include stator 302, encapsulant 306 and hall-effect sensor 308.

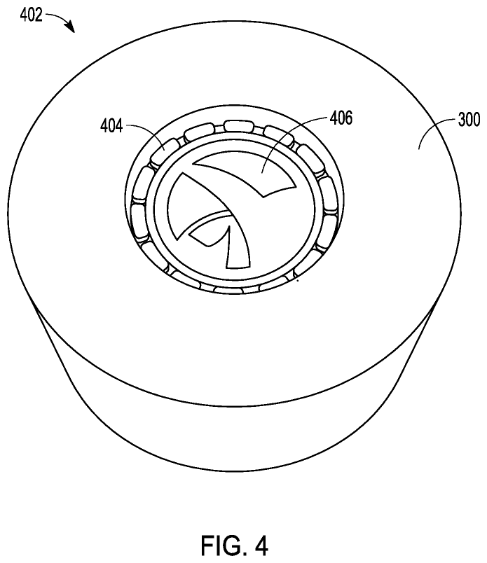

FIG. 4 illustrates an electric direct-drive motor, in accordance with some embodiments. Electric direct-drive motor 402 may include a fully-encapsulated stator 300 (FIG. 3) and rotor 404. Rotor 404 may be directly coupled to propeller 406, for example. Electric direct-drive motor 402 may be suitable for use as any of the electric direct-drive motors 202 (FIG. 2A and FIG. 2B). As illustrated in FIG. 4, the end of rotor 404 is shown with a pattern of magnetic poles and gaps between the poles.

Some embodiments are directed to an electric direct-drive motor for an underwater vehicle. In these embodiments, the electric direct-drive motor may comprise a fully-encapsulated stator and a rotor. In these embodiments, the fully-encapsulated stator may comprise a stator encapsulated in a thermally-conductive and electrically-isolative encapsulant. The encapsulant may be configured to align the rotor within the fully-encapsulated stator. In these embodiments, the fully-encapsulated stator may have an internal surface to operate as a bearing surface for the rotor. In these embodiments, a radial gap between the rotor and the internal surface may provide a fluid bearing between the rotor and stator. In these embodiments, the internal surface of the fully-encapsulated stator operates as a bearing surface for the rotor and the radial gap provides a fluid bearing when operating in a flooded assembly.

In some embodiments, the internal surface of the fully-encapsulated stator includes micro-channels to allow fluid to circulate between the between an external surface of the rotor and the internal surface of the stator. In these embodiments, the micro-channels may comprise surface veins that create a fluid-bearing affect. In these embodiments, the micro-channels may reduce friction and heat generation via fluid circulation. In some embodiments, the fluid may be seawater.

In some embodiments, the fully-encapsulated stator comprises a lip on the internal surface and the rotor may be captured between the lip and an external housing of the motor to prevent any axial movement of the rotor.

In some embodiments, the stator may be fully encapsulated by the encapsulant to seal the stator from fluid ingress. In these embodiments, the encapsulant may provide an envelope around the stator making the motor pressure tolerant.

In some embodiments, the fluid may be seawater. In these embodiments, for operation in the underwater vehicle, the electric direct-drive motor may be configured to be exposed to a high external water pressure (e.g., full ocean depth) allowing the seawater at the external water pressure to provide the fluid bearing between the rotor and stator. These embodiments allow the electric direct-drive motor to be directly exposed to water and the high external water pressure. These embodiments also eliminate any need for a pressure compensated housing (e.g., an oil filled housing), as well a need for dynamic seals and bearings.

In some embodiments, the underwater vehicle may be devoid of static/dynamic seals that prevent the seawater external to the underwater vehicle from entering the radial gap between the rotor and the internal surface of the fully-encapsulated stator.

In some embodiments, the rotor includes a coating to reduce friction between the rotor and the internal surface of the fully-encapsulated stator. In these embodiments, the coating may be a thin coating such as ceramic or

Polytetrafluoroethylene (PTFE), having a low coefficient of friction, although the scope of the embodiment is not limited in this respect.

In some embodiments, the encapsulant comprises an epoxy. In these embodiments, the epoxy may have a thermal conductivity ranging from approximately 0.5-1.5 W/(m*K) to provide heat transfer between the seawater and the stator, and an electrical isolation of at least 500 k ohms to prevent electrical conduction through the seawater (which is conductive) between the rotor and the stator. In these embodiments, the electric direct-drive motor may be able to operate within a conductive fluid, such as seawater.

In some embodiments, the epoxy further has a viscosity ranging from approximately 15-50 cP, a water absorption of approximately less than 0.2%, a temperature range of approximately −40° C.-100° C., and a hardness ranging from approximately 75-95 Shore D, although the scope of the embodiments is not limited in this respect. In these embodiments, an epoxy having a high thermal conductivity, a low viscosity, a low water absorption, high temperature range, cures hard and may be preferably non-transparent may be used, although the scope of the embodiments is not limited in this respect. Some suitable encapsulants include Stycast 2850 or 2651, Lord Cool Therm EP-340, Lord Circalok 6035, and Epic resins S7136 series, although the scope of the embodiments is not limited in this respect as other encapsulants may also be suitable.

In some embodiments, the radial gap between the rotor and an internal surface of the fully-encapsulated stator may be tightly controlled and ranges from approximately two to four thousandths of an inch.

In some embodiments, the fully-encapsulated stator includes a hall-effect sensor. The hall-effect sensor may comprise a ring within the stator to provide feedback to control circuitry (i.e., for phase information). In some embodiments, the electric direct-drive motor may be configured to operate as a thruster motor for the underwater vehicle. In some embodiments, the underwater vehicle may be an autonomous underwater vehicle (AUV) configured for operation in the seawater.

Some embodiments are directed to an autonomous underwater vehicle (AUV). In these embodiments, the AUV may comprise a first and a second electric direct-drive motor. The AUV may also include control circuitry coupled to hall-effect sensors of the first and second electric direct-drive motors configured to control operation of the motors. In these embodiments, each of the electric direct-drive motors may comprise a fully-encapsulated stator and a rotor. In these embodiments, the fully-encapsulated stator may comprise a stator fully-encapsulated in a thermally-conductive and electrically-isolative encapsulant. The encapsulant may be configured to align the rotor within the fully-encapsulated stator. In these embodiments, the fully-encapsulated stator may have an internal surface to operate as a bearing surface for the rotor. In some of these embodiments, a radial gap between the rotor and the internal surface may provide a fluid bearing between the rotor and stator.

In some embodiments, the first electric direct-drive motor may be coupled to an impeller to operate as a thruster motor and the second electric direct-drive motor may be coupled to a nozzle to direct flow produced by the first electric direct-drive motor. In these embodiments, the control circuitry may control thrust of the AUV with the first electric direct-drive motor and control direction of the AUV with the second electric direct-drive motor.

In some embodiments, the internal surface of the fully-encapsulated stator of each of the electric direct-drive motors includes micro-channels to allow fluid to circulate between an external surface of the rotor and the internal surface of the stator. In some embodiments, the fluid may be seawater and the electric direct-drive motors may be configured to be exposed to a high external water pressure allowing seawater at the external water pressure to provide the fluid bearing between the rotor and stator. In these embodiments, the underwater vehicle may be devoid of seals that prevent the seawater external to the underwater vehicle from entering the radial gap between the rotor and the internal surface of the fully-encapsulated stator.

Some embodiments are directed to a fully-encapsulated stator configured for an electric direct-drive motor. In these embodiments, the fully-encapsulated stator may comprise a thermally-conductive and electrically-isolative encapsulant. In these embodiments, the fully-encapsulated stator may also comprise a stator comprising stator windings fully encapsulated in the encapsulant. In these embodiments, the encapsulant may be configured to provide alignment for a rotor within the fully-encapsulated stator. In these embodiments, the fully-encapsulated stator may have an internal surface to operate as a bearing surface for the rotor. In these embodiments, a radial gap between the rotor and the internal surface provides a fluid bearing between the rotor and stator for operation underwater.

In some embodiments, the internal surface of the fully-encapsulated stator may include micro-channels to allow fluid to circulate between an external surface of the rotor and the internal surface of the stator. In these embodiments, the fully-encapsulated stator may comprise a lip on the internal surface to prevent axial movement of the rotor.

Some embodiments disclosed herein are directed to an underwater vehicle that is able to withstand and operate under high external pressure (full ocean depth). The underwater vehicle includes electric motors that are compact and produce sufficient thrust to maneuver and control an underwater vehicle. In some embodiments, the underwater vehicle is small and compact (e.g., ranging from 4 to 8 feet long and ranging from 5 to 8 inches in diameter).

Some embodiments eliminate the need of static/dynamic seals, alignment bearings, and a pressure compensated housing to enable use of electric motors underwater at ocean depth. These embodiments may also eliminate the need for secondary components based on typical design practices such as shafts, mounting hardware, etc.

Some embodiments are directed to an electric direct drive motor that includes a hall-effect sensor. The direct drive motor may include an external stator (stationary part) and internal rotor (rotating part). In some of these embodiments, the stator may be fully encapsulated using an epoxy that is electrically isolative, thermally conductive, resistant to thermal shock, has a low CTE (coefficient of thermal expansion), and low water absorption. In some embodiments, the rotor may be coated with a thin ceramic or PTFE (or similar) coating to reduce coefficient of friction between the rotor and encapsulant. In these embodiments, the rotor can be customized to include a nozzle, propeller, impeller, etc. that is specific to the application and function.

In some embodiments, a gap between the rotor and encapsulated stator is tightly controlled and may include microchannels or surface veins to create a “water bearing” affect. This reduces friction, improves efficiency, and reduces heat generation through constant water circulation. In some embodiments, a magnetic-bearing feature may optionally be used to control axial alignment between the rotor and stator, although the scope of the embodiments is not limited in this respect.

In some embodiments, multifaceted use of epoxy provides a sealing barrier, corrosion prevention, and a mechanical interface. The epoxy may also provide for thermal conduction (i.e., cooling) as well as component protection against physical impacts/scrapes allowing external exposure in assemblies. The epoxy also may allow for continuous rotational operation or cyclical oscillation of the motor.

In some embodiments, the electric direct-drive motor may be full ocean depth pressure tolerant and can be used in any underwater application. These embodiments reduce part count of underwater motors and eliminates pressure compensated (or oil filled) housings, dynamic shaft seals, and bearings. These embodiments are easily adaptable and scalable to a variety of functions and size requirements and utilize commercially available, off the shelf components. These embodiments provide operational flexibility to include continuous rotation or discrete cycle oscillation. In these embodiments, the encapsulant provides mechanical features to facilitate rotor alignment and bearing surfaces while providing the thermal path to extract heat from the motor windings to surrounding seawater. In some embodiments, the interface between the rotor and encapsulated stator creates a “water bearing” affect for component alignment, water circulation (for cooling), and reduced friction (for efficiency).

The Abstract is provided to comply with 37 C.F.R. Section 1.72 (b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An electric direct-drive motor for an underwater vehicle, the electric direct-drive motor comprising:
a fully-encapsulated stator; and a rotor,
wherein the fully-encapsulated stator comprises a stator encapsulated in a thermally-conductive and electrically-isolative encapsulant, the encapsulant configured to align the rotor within the fully-encapsulated stator, the fully-encapsulated stator having an internal surface to operate as a bearing surface for the rotor, and
wherein a radial gap between the rotor and the internal surface provides a fluid bearing between the rotor and stator.

2. The electric direct-drive motor of claim 1, wherein the internal surface of the fully-encapsulated stator includes micro-channels to allow fluid to circulate between an external surface of the rotor and the internal surface of the stator.

3. The electric direct-drive motor of claim 2, wherein the fully-encapsulated stator comprises a lip, and
wherein the rotor is captured between the lip and an external housing to prevent axial movement of the rotor.

4. The electric direct-drive motor of claim 3, wherein the stator is fully encapsulated by the encapsulant to seal the stator from fluid ingress.

5. The electric direct-drive motor of claim 4, wherein the fluid is seawater, and
wherein for operation in the underwater vehicle, the electric direct-drive motor is configured to be exposed to external water pressure allowing the seawater at the external water pressure to provide the fluid bearing between the rotor and stator.

6. The electric direct-drive motor of claim 5, wherein the underwater vehicle is devoid of seals that prevent the seawater external to the underwater vehicle from entering the radial gap between the rotor and the internal surface of the fully-encapsulated stator.

7. The electric direct-drive motor of claim 5, wherein the rotor includes a coating to reduce friction between the rotor and the internal surface of the fully-encapsulated stator.

8. The electric direct-drive motor of claim 7, wherein the encapsulant comprises an epoxy, wherein the epoxy has:
a thermal conductivity ranging from approximately 0.5-1.5 W/(m*K) to provide heat transfer between the seawater and the stator; and
an electrical isolation of at least 500 k ohms to prevent electrical conduction through the seawater between the rotor and the stator.

9. The electric direct-drive motor of claim 8, wherein the epoxy further has:
a viscosity ranging from approximately 15-50 cP;
a water absorption of approximately less than 0.2%;
a temperature range of approximately −40° C.-100° C.; and
a hardness ranging from approximately 75-95 Shore D.

10. The electric direct-drive motor of claim 7, wherein the radial gap between the rotor and an internal surface of the fully-encapsulated stator ranges from approximately two to four thousandths of an inch.

11. The electric direct-drive motor of claim 5, wherein the fully-encapsulated stator includes a hall-effect sensor, and
wherein the hall-effect sensor comprises a ring within the stator to provide feedback to control circuitry.

12. The electric direct-drive motor of claim 5, wherein the electric direct-drive motor is configured to operate as a thruster motor for the underwater vehicle.

13. The electric direct-drive motor of claim 12, wherein the underwater vehicle is an autonomous underwater vehicle (AUV) configured for operation in the seawater.

14. An autonomous underwater vehicle (AUV) comprising:
a first and a second electric direct-drive motor; and
control circuitry coupled to hall-effect sensors of the first and second electric direct-drive motors configured to control operation of the motors,
wherein each of the electric direct-drive motors comprises:
a fully-encapsulated stator; and a rotor,
wherein the fully-encapsulated stator comprises a stator encapsulated in a thermally-conductive and electrically-isolative encapsulant, the encapsulant configured to align the rotor within the fully-encapsulated stator, the fully-encapsulated stator having an internal surface to operate as a bearing surface for the rotor, and
wherein a radial gap between the rotor and the internal surface provides a fluid bearing between the rotor and stator.

15. The AUV of claim 14, wherein the first electric direct-drive motor is coupled to an impeller to operate as a thruster motor and the second electric direct-drive motor is couple to a nozzle to direct flow produced by the first electric direct-drive motor, and
wherein the control circuitry is to control thrust of the AUV with the first electric direct-drive motor and control direction of the AUV with the second electric direct-drive motor.

16. The AUV of claim 15, wherein the internal surface of the fully-encapsulated stator of each of the electric direct-drive motors includes micro-channels to allow fluid to circulate between an external surface of the rotor and the internal surface of the stator.

17. The AUV of claim 16, wherein the fluid is seawater, and
wherein the electric direct-drive motors are configured to be exposed to external water pressure allowing seawater at the external water pressure to provide the fluid bearing between the rotor and stator.

18. The AUV of claim 17, wherein the underwater vehicle is devoid of seals that prevent the seawater external to the underwater vehicle from entering the radial gap between the rotor and the internal surface of the fully-encapsulated stator.

19. A fully-encapsulated stator configured for an electric direct-drive motor, the fully-encapsulated stator comprising:
a thermally-conductive and electrically-isolative encapsulant; and
a stator comprising stator windings fully encapsulated in the encapsulant, the encapsulant configured to provide alignment for a rotor within the fully-encapsulated stator, the fully-encapsulated stator having an internal surface to operate as a bearing surface for the rotor, and
wherein a radial gap between the rotor and the internal surface provides a fluid bearing between the rotor and stator for operation underwater.

20. The fully-encapsulated stator of claim 19, wherein the internal surface of the fully-encapsulated stator includes micro-channels to allow fluid to circulate between an external surface of the rotor and the internal surface of the stator, and
wherein the fully-encapsulated stator comprises a lip on the internal surface to prevent axial movement of the rotor.
